(19) United States
(12) Patent Application Publication
(10) Pub. No.: US 2014/0097552 A1
(43) Pub. Date: Apr. 10, 2014

(54) MOLD SCRAP SEPARATING APPARATUS AND METHOD OF USING THE APPARATUS

(71) Applicant: DTR INDUSTRIES, INC., Bluffton, OH (US)

(72) Inventors: Michael K. Klingler, Bluffton, OH (US); David B. Niese, Ottawa, OH (US); Marshall W. Tracy, Ottawa, OH (US)

(73) Assignee: DTR INDUSTRIES, INC., Bluffton, OH (US)

(21) Appl. No.: 13/735,208

(22) Filed: Jan. 7, 2013

Related U.S. Application Data
(60) Provisional application No. 61/711,456, filed on Oct. 9, 2012.

(51) Int. Cl. B29C 33/72

(52) U.S. Cl. CPC B29C 33/72
USPC 264/39; 425/216

(57) ABSTRACT

An apparatus for separating mold scrap from a mold and having a first plate with a first engaging edge and a second plate with a second engaging edge. The plates are in overlying relationship. A grip actuating assembly moves at least one of the first and second plates relative to the other of the first and second plates in a first path to change the apparatus between: a) starting state wherein a projecting piece of mold scrap can be directed to between the first and second engaging edges; and b) a gripping state wherein the projecting piece of mold scrap is gripped. The first and second plates can be repositioned in a second path to separate the gripped projecting piece of mold scrap from an associated mold.

### CROSS-REFERENCE TO RELATED APPLICATIONS

This application is a non-provisional of Application No. 61/711,456 filed Oct. 9, 2012.

### BACKGROUND OF THE INVENTION

### Field of the Invention

This invention relates to molding systems and, more particularly, to an apparatus for separating scrap material from molded products and/or mold components. The invention is also directed to a method of using the apparatus.

Myriad apparatus currently exist for forming parts through a process initiated by introducing a flowable material into a mold cavity. Many of these apparatus operate so that excess mold material is solidified on mold parts and must be separated during the parts forming process. As one example, certain rubber forming molds have a network of runners and sprues that deliver the molding material in a flowable state from a supply thereof simultaneously to a plurality of discrete cavities in which parts are formed. As the parts are cured during a processing cycle, the mold material solidifies in the runners and sprues and may additionally overflow and produce flash that must be separated from the mold and/or parts together with the runners and sprues.

It is known to use automated grippers to engage and “pull” the runners and sprue at the completion of a cycle. To effectively separate the runners and sprues, they must be engaged simultaneously at several spaced locations and drawn away from the molds. If the separating forces are not distributed to separate the scrap in one drawing action, the joined network of runners and sprees is likely to be torn, which could necessitate manual separation of part, or the entirety, of the scrap material, in a separate step or steps.

It is common for molds to have multiple cavities, which may number twelve or more. With conventional automated pullers, there are multiple options for their design. One or more discrete pullers, which are less in number than the required pull locations, can be operated to serially grip and pull the runners and sprues at different locations until the entire network thereof can be separated. Alternatively, the number of pullers can be equal in number to pull locations required to separate the network of runners and sprees as a single mass without causing tearing thereof.

With the former design, a relatively complicated structure and control system may be required to effect operation. Further, the multiple movements required for the puller(s) lengthens the cycle time. Also, as noted above, tearing of the contiguous scrap mass may complicate the separation process and necessitate the performance of steps carried out manually. Thus, there is a considerable expense associated with constructing such systems and their use, with the latter cost attributable to inefficiencies resulting from lengthened cycle times and possibly the need for manual follow-up steps.

The latter design is expensive particularly from the standpoint of construction. The coordination of multiple pullers also introduces complications. Still further, the multiple pullers are required to all function consistently to effectively pull the entire network of runners and sprues. Failure of any one or more of the pullers may necessitate shutting down of a system. Alternatively, upon there being a failure, an operator may resort to manual separation of the runners and sprues.

Still further, the nature of the aforementioned pullers is such that they are relatively complicated in terms of their design. Cooperating jaws produce the gripping force. For various reasons, the gripping may be compromised, which could lead to inoperability of the pulling system.

Systems such as the above also tend to take up space on fabrication lines which is at a premium in most facilities. The pulling systems may also occupy space so as to block access to other regions of the apparatus, required for operation, maintenance, and repair.

Because of cost concerns, space limitations, and reliability concerns, many manufacturing facilities have chosen to pull and separate runners and sprues through manually performed steps. Commonly at the completion of the parts forming portion of a mold cycle, mold parts will be separated to expose the runners, sprues, and flash. At that point, an operator typically directly grips and separates, or uses a handheld tool to grip and separate, the scrap by doing so serially at a plurality of locations.

In a common mold configuration, the scrap solidifies in vertically opening passageways. To separate the material from these passageways, the operator is required to effect a positive grip on the material within these passageways and produce an upward force simultaneously as a twisting action is carried out that tends to break the molded material free. In a single cycle, the operator will be required to reproduce this action a multiple of times. In so doing, the operator may also place his/her fingers against the mold to produce a fulcrum about which the hand is braced and pivoted to effect scrap separation.

Since mold cycles are relatively short, an operator may be required to repeat this action potentially thousands of times a day. This may produce fatigue of the digits and limbs and, in a worst case, injuries that may necessitate treatment, potentially involving rest. Consequently, fatigue and injury may lead to employee downtime, increased medical costs, and reduced production by those individuals who continue to perform with chronic injury and/or fatigue.

This problem is aggravated by the fact that the scrap pulling is performed on molds heated to elevated temperatures. Increasing “touches” increases the likelihood of heat-related injuries and also necessitates the use of protective clothing that may be inhibiting of operator movement and cause an uncomfortable level of heat retention in an environment that is normally at an elevated temperature due to the operation of the molding equipment.

Parts manufacturers are always faced with the need to control costs. As competition increases, margins are even further reduced. In spite of the need to utilize more efficient equipment, the manufacturers in this industry have continued to use primarily manual processes in separating scrap at the completion of the parts forming portion of a mold cycle. This is attributable to the fact that no commercially viable system has been devised that is usable to minimize manual steps associated with scrap pulling/separation.

### SUMMARY OF THE INVENTION

In one form, the invention is directed to an apparatus for separating mold scrap from a mold. The apparatus includes: a first plate having a first engaging edge; a second plate having a second engaging edge, with one of the first and second plates overlying the other of the first and second plates; and a grip actuating assembly for moving at least one of the first and second plates relative to the other of the first and second plates in a first path to change the apparatus between: a) a starting state wherein a projecting piece of mold scrap can be directed to between the first and second engaging edges; and b) a gripping state wherein a projecting piece of mold scrap between the first and second edges, with the apparatus in the starting state, is gripped by the first and second engaging edges. The first and second plates can be repositioned in a second path to separate the gripped projecting piece of mold scrap from an associated mold upon which the projecting piece of mold scrap is formed.

In one form, the first path is substantially straight.

In one form, the first plate has a first flat surface and the second plate has a second flat surface. The first and second flat surfaces respectively reside in substantially parallel first and second planes and face each other. The first path is substantially parallel to the first and second planes.

In one form, the apparatus further includes a third plate having a third engaging edge and the second plate resides between the first and third plates. With the apparatus in the starting state, a projecting piece of mold scrap can be directed between the second and third edges. By changing the apparatus from the starting state into the gripping state a projecting piece of mold scrap between the second and third edges, with the apparatus in the starting state, is gripped by the second and third engaging edges. The first, second and third plates can be relatively repositioned to separate the piece of mold scrap gripped between the first and second engaging edges and second and third engaging edges from an associated mold upon which the projecting piece of mold scrap is formed.

In one form, the second plate has another flat surface that is substantially parallel with and faces oppositely to the second surface. The third plate has a third flat surface. The third flat surface and another flat surface respectively reside in substantially parallel third and another flat planes and face each other.

In one form, the third plate is movable with the first and second plates in the second path to separate the gripped projecting piece of mold scrap from a mold. The second path is substantially orthogonal to the first path.

In one form, the apparatus for separating mold scrap further includes a support for the first and second plates.

In one form, there is a drive assembly for selectively moving the first and second plates in opposite directions in the second path.

In one form, the apparatus for separating mold scrap further has: a) a support for the first and second plates, with the first and second plates movable through the support vertically in the second path; and b) a counterbalance assembly. The counterbalance assembly cooperates with the first and second plates to counterbalance a weight of the first and second plates to thereby facilitate raising of the first and second plates.

In one form, there is at least one other engaging edge on each of the first and second plates that cooperate with each other and a projecting piece of mold scrap in the same way the first and second engaging edges cooperate with each other and a projecting piece of mold scrap.

In one form, there is at least one other engaging edge on each of the first, second, and third plates that cooperate with each other and a projecting piece of mold scrap in the same way the first, second, and third engaging edges cooperate with each other and a projecting piece of mold scrap.

In one form, the apparatus for separating mold scrap is provided in combination with a mold assembly with mold scrap, including the projecting piece of mold scrap, thereon. The projecting piece of mold scrap has a projecting length. The projecting piece of mold scrap has a substantially circular peripheral shape in cross-section taken transversely to the projecting length.

In one form, the first and second engaging edges each is substantially U-shaped, with the “U” shape of each of the first and second edges opening towards each other.

In one form, the mold assembly has openings in which the mold scrap resides.

In one form, the invention is directed to a method of using an apparatus for separating mold scrap, as described above. The method includes the steps of: providing a mold assembly; directing mold material into the mold assembly to produce at least one part and mold scrap including at least first and second projecting pieces of mold scrap that project in parallel lines; placing the apparatus in the starting state; with the apparatus in the starting state moving the first and second plates in a first direction in the second path to thereby direct the first projecting piece of mold scrap between the first and second edges and the second and third edges and the second projecting piece of mold scrap between the one other of the engaging edges on the first and second plates and second and third plates; changing the apparatus from the starting state into the gripping state so that: a) the first projecting piece of mold scrap between the first and second engaging edges and second and third engaging edges is gripped by the first and second engaging edges and second and third engaging edges; and b) the second projecting piece of mold scrap between the one other of the engaging edges on the first, second and third plates is gripped by the one other of the engaging edges on the first and second plates and second and third plates; and with the apparatus in the gripping state moving the first and second plates oppositely to the first direction in the second path relative to the mold assembly to thereby separate at least a part of the mold scrap from the mold assembly.

In one form, the method is performed with the apparatus on a base upon which the mold assembly is provided and using a drive assembly. The steps of moving the first and second plates in the first direction and oppositely to the first direction in the second path consist of moving the first and second plates by operating the drive assembly.

In one form, the method is performed with the apparatus on a base upon which the mold assembly is provided. The step of moving the first and second plates in the first direction and oppositely to the first direction in the second path consists of manually engaging and moving the first and second plates relative to the mold assembly.

In one form, the method further includes the step of changing the apparatus from the gripping state back into the starting state after the at least part of the mold scrap is separated from the mold assembly to thereby allow release of the at least part of the mold scrap from the apparatus.

In one form, the method further includes the step of counterbalancing a weight of the first and second plates to facilitate manual movement of the first and second plates.

In one form, the step of directing mold material into the mold assembly involves injecting the mold material into the mold assembly.

### BRIEF DESCRIPTION OF THE DRAWINGS

FIG. 1 is a schematic representation of a conventional injection molding system and incorporating a mold in which parts are formed;

FIG. 2 is a perspective view of one of the mold parts on the system in FIG. 1 upon which mold scrap is formed during parts formation;

FIG. 3 is a view as in FIG. 2 and showing hands of an individual manually removing the mold scrap;

FIG. 4 is a fragmentary, side elevation view of one specific form of injection molding system, shown in FIG. 1, and with a mold operatively positioned to receive molten material for parts formation;

FIG. 5 is a view as in FIG. 4 wherein the mold is moved to a staging position;

FIG. 6 is a view as in FIG. 5 and incorporating an apparatus for separating mold scrap from the mold, according to the invention, and with a plate assembly thereon in a raised position;

FIG. 7 is a view as in FIG. 6 wherein the plate assembly has been lowered to engage and grip mold scrap on the mold;

FIG. 8 is a view as in FIG. 7 with the plate assembly elevated together with the gripped mold scrap;

FIG. 9 is a view as in FIG. 8 wherein the mold scrap has been released from the plate assembly;

FIG. 10 is an enlarged, side elevation view of three plates making up the plate assembly in FIGS. 6-9;

FIG. 11 is a bottom view of a top plate on the plate assembly in FIG. 10;

FIG. 12 is a plan view of a middle plate on the plate assembly in FIG. 10;

FIG. 13 is a plan view of a bottom plate on the plate assembly in FIG. 10;

FIG. 14 is a partially schematic representation of a mold part with scrap including a projection to be engaged and gripped by the plate assembly;

FIG. 15 is an enlarged, cross-sectional view of the projection taken along line 15-15 of FIG. 14;

FIG. 16 is an enlarged, fragmentary, plan view of a section of the mold scrap with projections as in FIGS. 14 and 15 thereon;

FIG. 17 is an exploded perspective view of the plate assembly in FIG. 10;

FIG. 18 is an enlarged, fragmentary, perspective view of an actuating assembly for relatively moving the plates on the plate assembly to change the state of the apparatus;

FIG. 19 is a view as in FIG. 18 wherein the apparatus has been changed to another state through operation of the actuating assembly;

FIGS. 20-24 are schematic showings of a sequence of operating the inventive apparatus using the plate assembly to engage and grip a projection on mold scrap, separate the mold scrap from a mold, and release the mold scrap from the plate assembly;

FIG. 25 is a view as in FIG. 14 and showing a modified form of protrusion;

FIG. 26 is an enlarged, cross-sectional view of the protrusion taken along line 26-26 of FIG. 25;

FIGS. 27-31 are sequence drawings corresponding successively to FIGS. 20-24 and with a modified form of plate assembly, according to the invention;

FIG. 32 is a fragmentary, perspective view of an injection molding system with a modified form of apparatus, according to the present invention, for separating mold scrap from a mold and wherein a plate assembly thereon is manually repositionable by an operator;

FIG. 33 is a reduced, fragmentary, side elevation view of the components in FIG. 32 with the plate assembly elevated above a mold with scrap thereon;

FIG. 34 is a view as in FIG. 33 wherein the plate assembly has been lowered to engage and grip the scrap;

FIG. 35 is a view as in FIG. 34 wherein the plate assembly has been raised to separate the scrap from the mold;

FIG. 36 is a view as in FIG. 35 wherein the mold scrap has been released from the plate assembly;

FIG. 37 is a front elevation view of an injection molding system incorporating a modified form of apparatus, according to the invention, for separating mold scrap from a mold wherein a plate assembly thereon is shown in a raised position relative to the mold;

FIG. 38 is a side elevation view of the system in the FIG. 37 state;

FIG. 39 is an enlarged, fragmentary, side elevation view of the system in FIGS. 37 and 38 wherein the plate assembly is elevated above the staged mold;

FIG. 40 is a view as in FIG. 39 wherein the plate assembly is engaged with and gripping scrap on the mold;

FIG. 41 is a view as in FIG. 40 wherein the plate assembly has been raised and pivoted; and

FIG. 42 is a view as in FIG. 41 wherein the state of the apparatus has been changed to release the scrap from the plate assembly.

### DETAILED DESCRIPTION OF THE PREFERRED EMBODIMENT

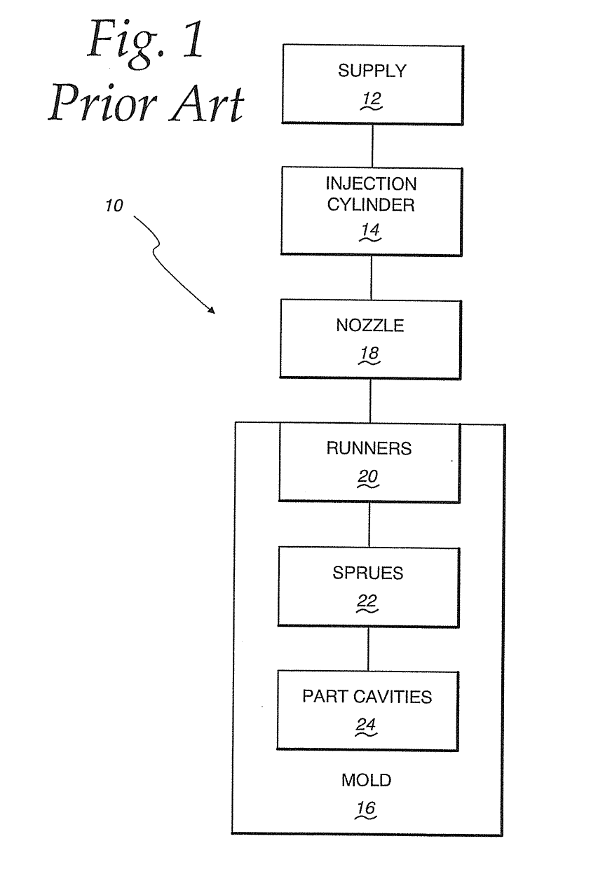

In FIG. 1, a conventional injection molding system for producing discrete parts, and that is suitable for incorporation of the present invention, is shown schematically at 10. The precise construction of the separate system components is not critical to the present invention. The system 10 is shown schematically to encompass virtually any system in which a flowable material is injected into cavities to form parts and on which scrap is generated that must be separated from the parts and the mold components during each operating cycle. While the invention is particularly useful for rubber injection molding, it is not so limited.

In the system 10, a material supply is provided at 12. The supply 12 may be a bulk supply or a portioned quantity of the material.

The material from the supply 12 is heated and delivered to an injection cylinder 14, as by means of a screw-type extruder. The material fills the cylinder 14 to a specified volume. At the appropriate time within the operating cycle, the material is injected into a mold 16 through a nozzle 18. The material, which is in a molten state and thus flowable, is delivered through a network of runners 20 and sprues 22 to discrete part cavities 24. Typically, the runners 20 are formed on an upper surface of the mold 16 to convey the molten material to the cavities 24. The sprues 22 define the channels through which the molten material enters and fills the individual part cavities 24.

Once the material in the part cavities 24 is solidified, material in the runners 20 and sprues 22 also solidifies so that there is a network of scrap that must be separated from the parts and the mold 16.

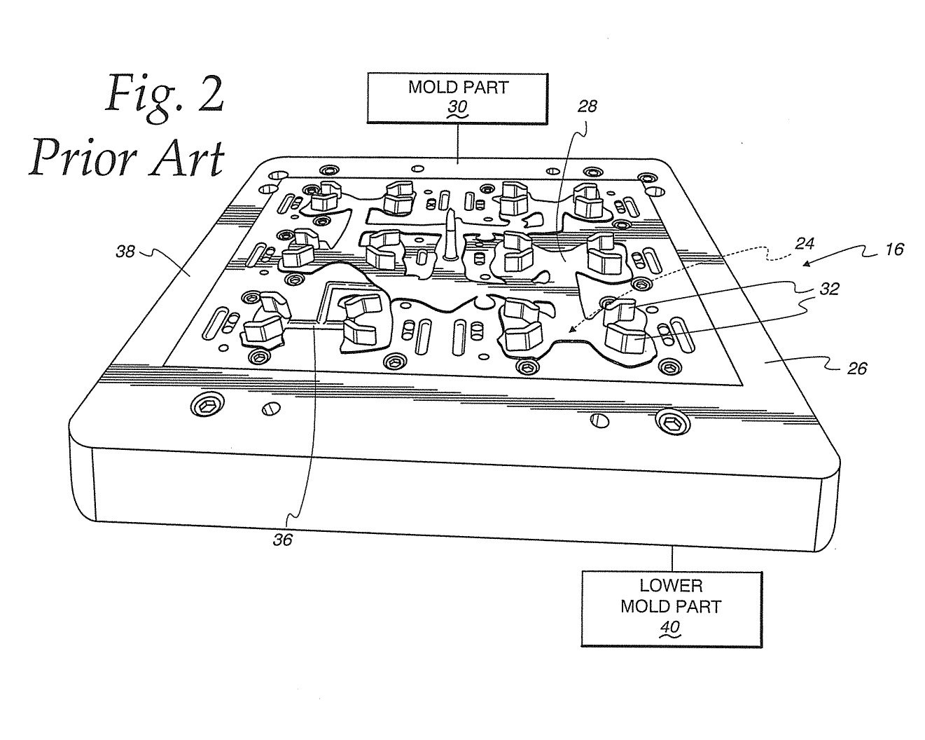

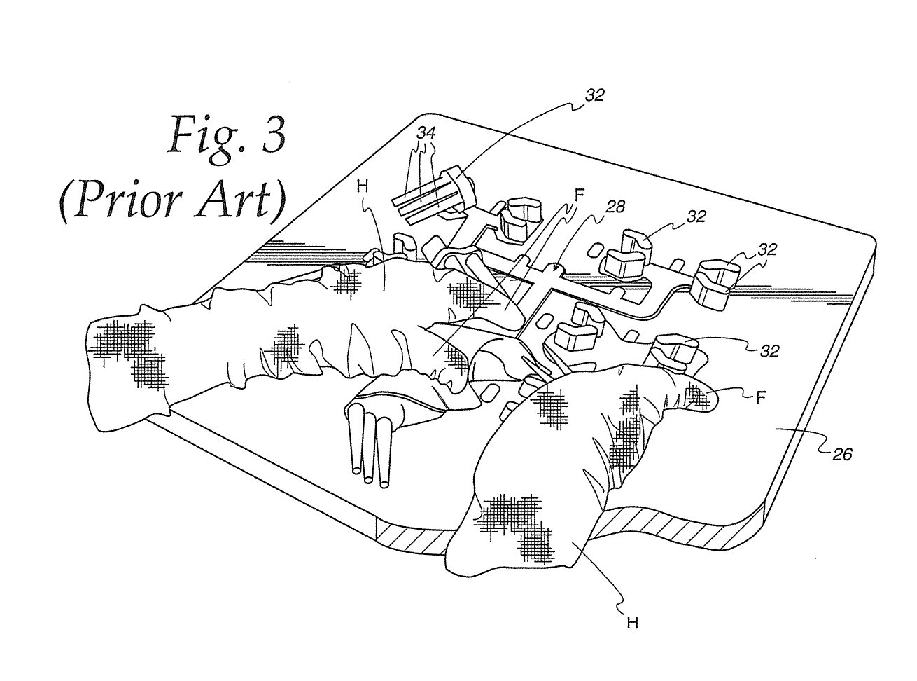

In FIGS. 2 and 3, an upper part 26 on the mold 16 is shown with a network of solidified material scrap 28 thereon. Separation of the mold part 26 from a separate mold part 30 exposes the scrap 28. The scrap 28 consists of a plurality of upward projections 32 formed in receptacles strategically placed in paired relationship in the vicinity of each of the part cavities 24. The arrangement of runners 20 and sprues 22 causes a plurality of depending fingers 34 to be formed unitarily with each of the projections 32.

The scrap 28 is required to be removed from the formed parts and mold 16 at the conclusion of the parts forming portion of each operating cycle.

In FIG. 3, the conventional process for manually removing the scrap 28 is shown. The system operator is required to manually grasp the projections 32 at each part cavity location to draw the fingers 34 outwardly from their complementarily-shaped receptacles and additionally draw the scrap 28 out of the upwardly opening channels 36 formed through the upper surface 38 of the upper part 26 and defining part of the material delivery network including the runners 20 and sprues 22.

To facilitate this process, the projections 32 are made with a shallow “V” shape that can be grasped between fingers F on an operator's hand H. The operator pinches the projections 32 at the cavity locations and exerts an upward force while simultaneously effecting a twisting action that breaks the scrap 28, and particularly the fingers 34, loose. The operator may also use his/her fingers as a fulcrum to effect a prying action. With the mold configuration shown in FIG. 3, this process is repeated at six different locations, preferably while maintaining the entire network of scrap intact so that it can be handled and disposed of as one piece.

Commonly, the pinching of the projections 32 takes place between the operator's thumb and his/her index finger. During the process, the operator's wrist and forearm regions are rotated. In a typical rubber injection system, the operator will be required to exert a force in the range of 13-23 pounds at each location. The manual manipulation of the scrap 28, to effect separation thereof, is done preparatory to opening the mold 16, which is effected by separating the upper mold part 26 from a lower mold part 40, thereby to expose the cavities 24 with the molded parts therein.

The above described actions by the operator create friction on the two tendons that control the thumb. This motion, together with the angle of the wrist, can cause the strained tendons to become fatigued and inflamed, and may result in hand and wrist pain. Also, repetitive twisting of the forearm can cause epicondylitis/tennis elbow, which affects the tendons in the elbow and shoulder.

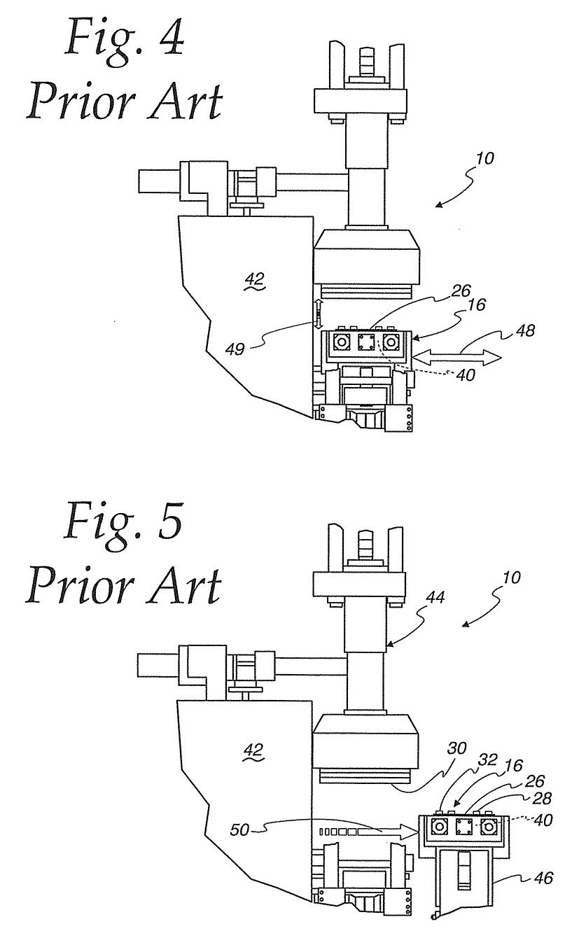

As seen in FIGS. 4 and 5, the system 10 incorporates mechanisms to controllably reposition the mold parts 26, 40 relative to the mold part 30 and a frame 42 that defines a support for the various components.

More particularly, a support 44 on the frame 42 maintains the mold part 30 operatively positioned relative to the frame 42.

The mold parts 26, 40, making up the mold assembly, are carried upon a pedestal support 46 through which the mold parts 26, 40 are movable in a controlled manner back and forth in a substantially linear, horizontal path, as indicated by the double-headed arrow 48, and back and forth in a substantially linear, vertical path, as indicated by the double-headed arrow 49.

At the initiation of a cycle, the mold parts 26, 40 are situated as in FIG. 4, with the mold parts 26, 40 thereafter raised to be coupled operatively with the upper mold part 30. Material from the supply 12 is injected into the cavities 24 via the runners 20 and sprues 22 through the intermediate injection cylinder 14 and nozzle 18. The material, in the event that it is rubber, is vulcanized in the cavities 24, after which the mold parts 26, 40 are lowered so that the mold part 26 is separated from the mold part, whereby the scrap 28 is exposed. The mold parts 26, 40 are then moved in the direction of the arrow 50 to a staging location so that the exposed scrap 28 is more readily accessible to be manually manipulated.

The parts 26, 40 of the mold assembly are the primary parts defining the part forming cavities 24 on the mold 16. In FIG. 4, the mold parts 26, 40 are shown lowered from their operative/molding position, whereas in FIG. 5 they are shown in a staging position to facilitate separation of the scrap 28 preparatory to accessing formed parts by opening the mold 16 through separation of the upper mold part 26 from the lower mold part 40.

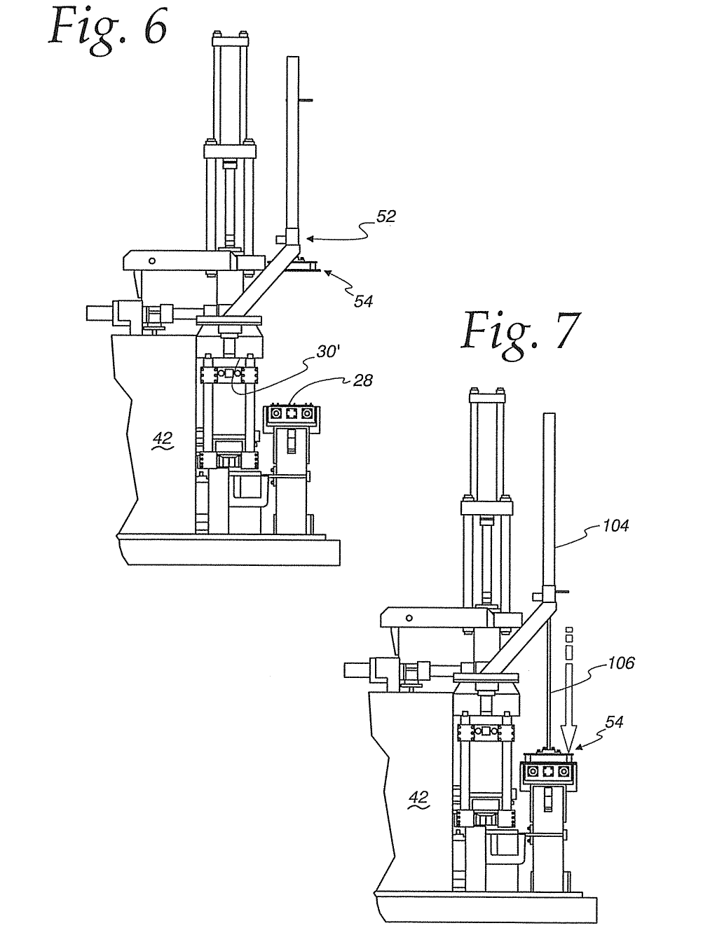

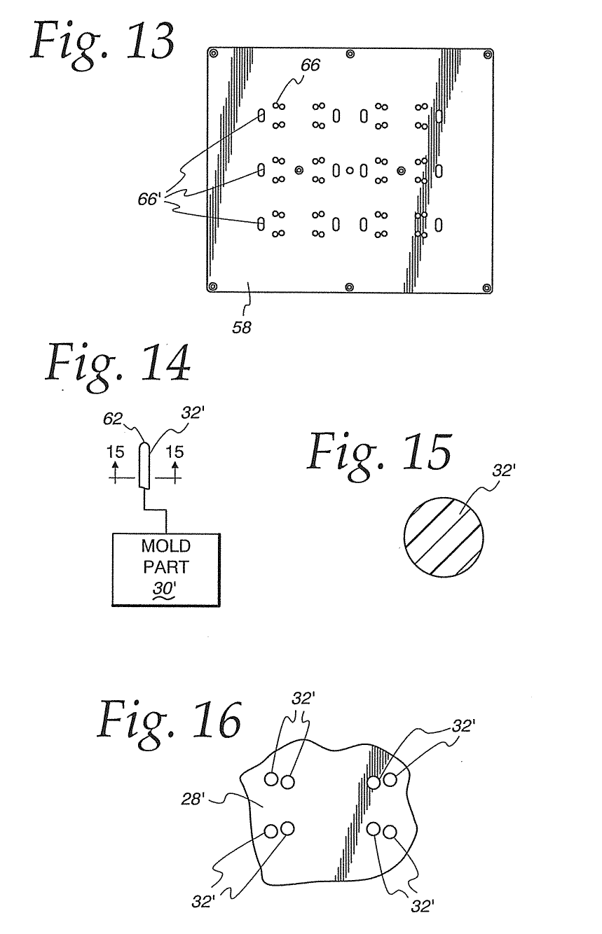

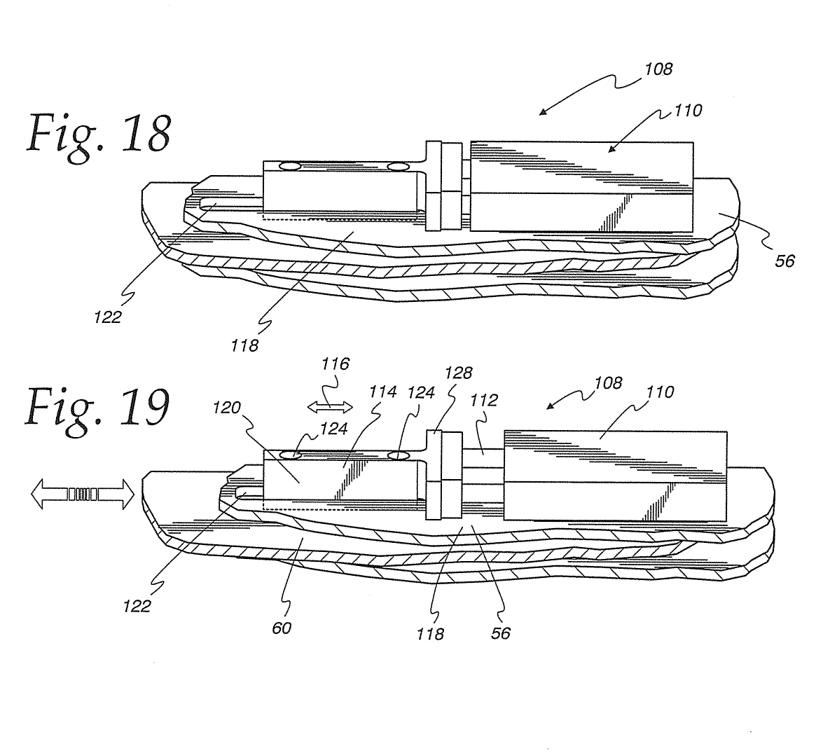

According to the invention, the basic system components described in FIGS. 1-5 are utilized and additionally an apparatus 52 for separating the mold scrap 28 from the mold, as shown in FIGS. 6-26, is incorporated. The description herein will be made with the understanding that the basic injection molding system 10, with which the scrap separating apparatus 52 is usable, is the same as described above, with either a retrofitted arrangement of the mold scrap separating apparatus 52 or an arrangement wherein the system 10 and apparatus 52 are more integrally formed, as at time of manufacture. The apparatus 52 could be incorporated in other manners, however that is not a critical part of the invention herein. Retrofitting is facilitated by causing the apparatus 52 to operate on the mold 16 in the aforementioned staging position, as shown in FIG. 6.

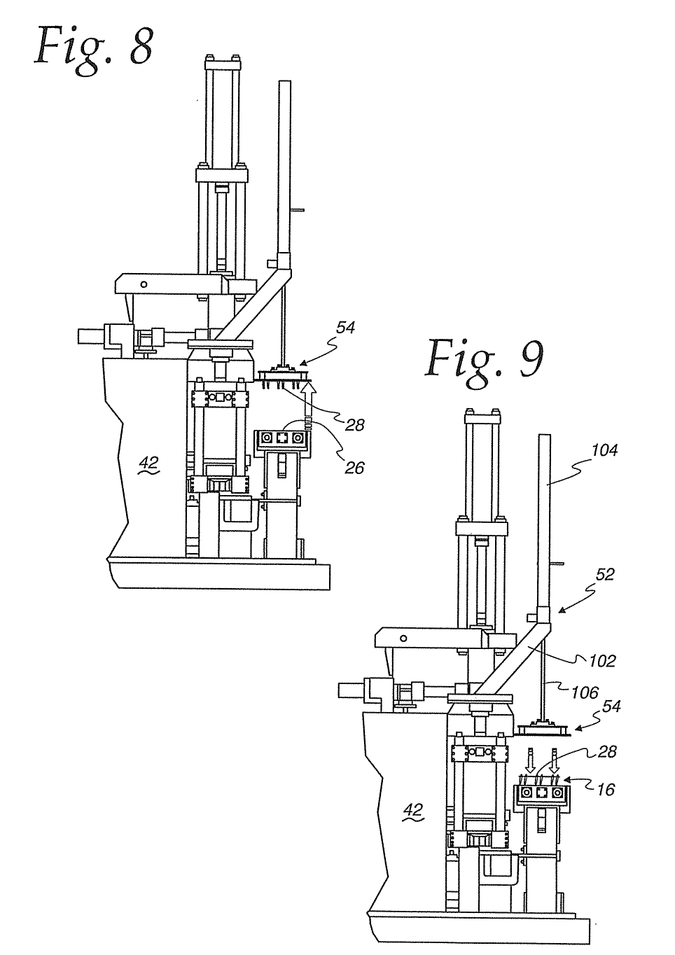

One form of the apparatus 52 consists of a plate assembly 54 that is mounted to the frame/support 42 for movement relative to the frame 42 between a retracted/inactive position, shown in FIG. 6, and an extended/operative position, as shown in FIG. 7. In the FIG. 7 position, the plate assembly 54 is situated to engage and grip the scrap 28, exposed with the mold 16 in the staging position therefor. The gripped scrap 28 can be separated from the mold 16 by elevating the plate assembly 54, as shown in FIG. 8, adequately to fully separate the scrap 28 from the mold 16, whereupon the scrap 28 can be released from the plate assembly 54, as shown in FIG. 9.

In one preferred form, the plate assembly 54 is made up of three plates—a top plate 56, bottom plate 58, and a middle plate 60 that resides between the top and bottom plates 56, 58. In one exemplary form, the plates 56, 58, 60 are all made from ⅛″ steel stock.

In this embodiment, the mold part 30, that produces the projections 32, is replaced by a mold part 30′ that causes upwardly directed projections 32′ to be formed, as shown schematically in FIG. 14, as part of the scrap 28′ that must be separated. The projections 32′ have a substantially cylindrical shape, with a generally circular cross-section, as shown clearly in FIG. 15. The upper, leading ends 62 of the projections 32′ are tapered and slightly rounded.

The mold part 30′ is configured to produce a pattern of projections 32′ on the scrap 28′ in association with each part cavity 24. This particular arrangement is not critical to the present invention and is but one exemplary and preferred form for the projections 32′. As will become apparent after reading the further description herein, virtually an unlimited number of different arrangements of projections, size of projections, and shape of projections, might be utilized consistently with the inventive concepts.

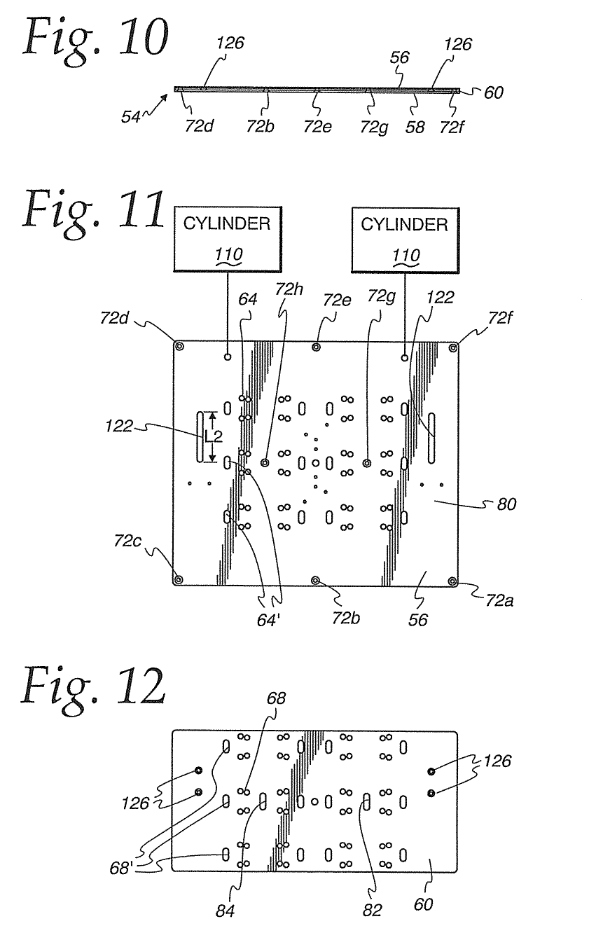

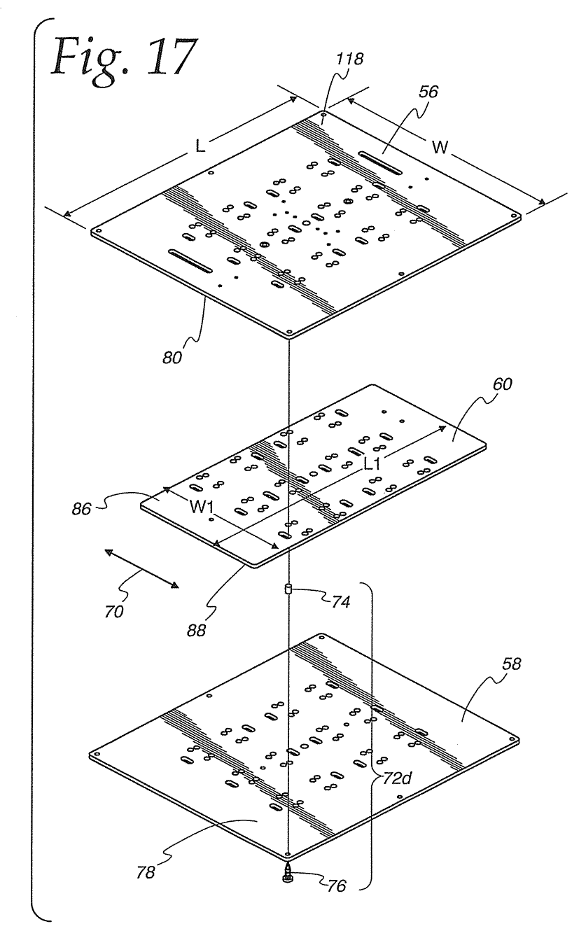

The plates 56, 58, 60 are configured so that when they are in assembled and over- and under-lying relationship, as shown in FIG. 10, and in a first state, through openings 64, 66, 68, successively in the plates 56, 58, 60, are registered with each other to accept a corresponding number of the projections 32′ on the scrap 28′ produced on the mold 16. The state of the apparatus 52 can be changed by translating the middle plate 60 in a limited range in a first path, relative to the overlying top and underlying bottom plates 56, 58, as indicated by the double-headed arrow 70 in FIG. 17.

The plates 56, 58, 60 are operatively interconnected by using, in this case, six perimeter spacers 72a, 72b, 72c, 72d, 72e, 72f. Exemplary spacer 72d, as seen most clearly in FIG. 17, consists of a spacing element 74 and a threaded fastener 76 that extends through the bottom plate 58 and spacing element 74 and into the top plate 56 so that the spacing element 74 maintains a fixed spacing dimension between a flat, upwardly facing surface 78 on the bottom plate 58, and a flat, downwardly facing surface 80 on the top plate 56. All spacers 72a-72f are similarly constructed so that there is a securely maintained, uniform spacing dimension between the planes of the surfaces 78, 80, which are substantially parallel to each other.

The top and bottom plates 56, 58 have the same length and width dimensions L, W. The middle plate 60 has a length dimension L1 that is less than the length dimension L and a width dimension W1 that is less than the width dimension W. This provides clearance around the periphery of the middle plate 60 so that the spacers 72 can be utilized without extending through the middle plate 60 or interfering therewith as the middle plate 60 is shifted in the first path relative to the top and bottom plates 56, 58, as hereinafter described.

Two additional spacers 72g, 72h, the same as the spacers 72a-72f, are provided and extend through elongate slots 82, 84 through the middle plate 60. The slots 82, 84 allow the middle plate 60 to shift back and forth in its first path.

The spacers 72a-72h maintain a spacing between the surfaces 78, 80 whereby an upwardly facing surface 86 on the middle plate 60 closely confronts the upper plate surface 80 and a downwardly facing surface 88 on the middle plate 60 closely confronts the surface 78 on the bottom plate 58. The planes of all surfaces 78, 80, 86, 88 are substantially parallel, whereby the middle plate 60 is guided relative to the top and bottom plates 56, 58 through face-to-face sliding contact between the surfaces 78, 88 and 80, 86. The spacing between the surfaces 78, 80 is sufficiently greater than the thickness of the middle plate 60 so that the plates 56, 58, 60 do not bend as the state of the apparatus 52 is changed.

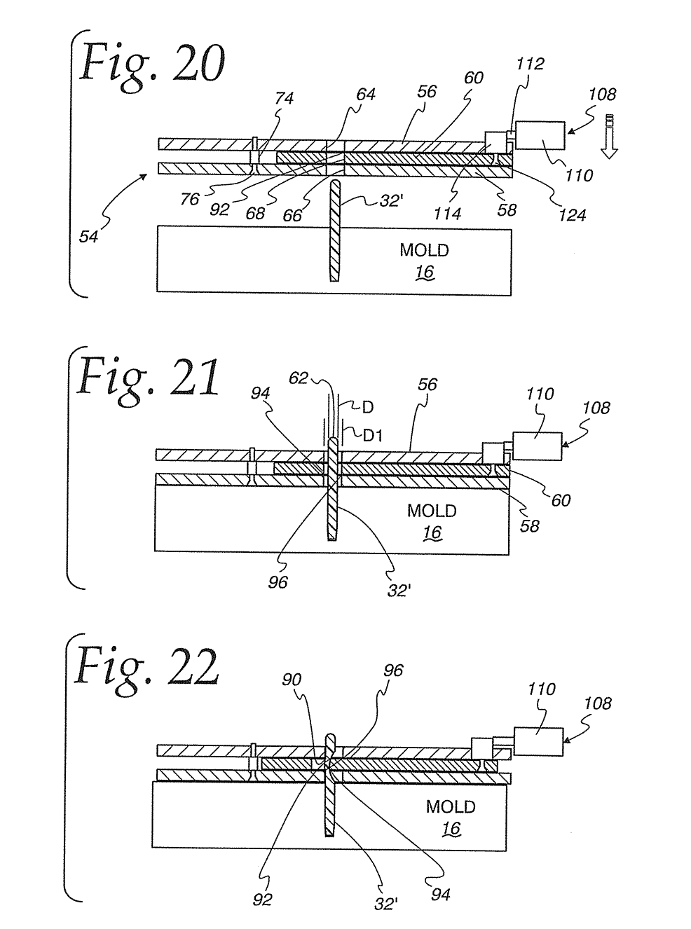

The operation of the apparatus 52 is, for purposes of clarity, described using schematic representations in FIGS. 20-24 to show the interaction between the plate assembly 54 and an exemplary projection 32′, with it being understood that the plate assembly 54 cooperates with all of the projections 32′ in substantially the same manner.

As seen in FIG. 20, the apparatus 52 is in a starting state wherein the plate openings 64, 66, 68, successively on the top, bottom, and middle plates 56, 58, 60, are in either full registration or adequately registered to allow the projection 32′ to be moved upwardly therethrough. In FIG. 20, the plate assembly 54 is shown being advanced downwardly towards the mold 16 and just prior to the plate assembly 54 realizing the extended/operative position in FIG. 7. The extended/operative position for the plate assembly 54 is shown in FIG. 21, wherein the bottom plate 58 is adjacent to, or abuts, the mold 16.

In this embodiment, the projection 32′ has a diameter D that is less than the diameter D1 of the openings 64, 66, 68 to allow unimpeded passage of the projection 32′. The openings 64, 66, 68 are not required to have the same diameter, so long as the registered diameter of all of the openings 64, 66, 68 will freely pass the projection 32′. The rounded and tapered configuration of the upper leading end 62 guides the projection 32′ into and through the openings 64, 66, 68, whereby the projection 32′ projects upwardly to beyond the plate assembly 54.

The apparatus 52 is changed from the starting state into a gripping state, as shown in FIG. 22, wherein the projection 32′ is pinched as a result of being gripped by the plates 56, 58, 60. More specifically, the projection 32′ resides between, and is gripped by, a U-shaped edge 90 on the top plate 56 and bounding the opening 64 and an oppositely opening, U-shaped edge 92 on the middle plate 60 bounding the opening 68. These “U” shapes are defined by, in the depicted embodiment, circular edge portions around the openings 64, 66, 68, that are circular. This circular shape is not required, as virtually an unlimited number of a different opening shapes might be devised by one skilled in the art to produce the requisite gripping on the projections 32. As but one alternative example, the openings could be nominally matched in shape to the projections 32.

The projection 32′ is similarly pinched and gripped by an edge 94 bounding the opening 68 and an oppositely opening, U-shaped edge 96 bounding the opening 66, between which the projection 32′ resides. The edges 92, 94 are defined on the same surface 98 that bounds the opening 68. The surface 98 bounding the opening 68 deforms the projection 32′ at one radial location into a concave shape at 100. This produces the aforementioned pinching action, whereby the plates 56, 58, 60 cooperate to firmly grip the deformed projection 32′.

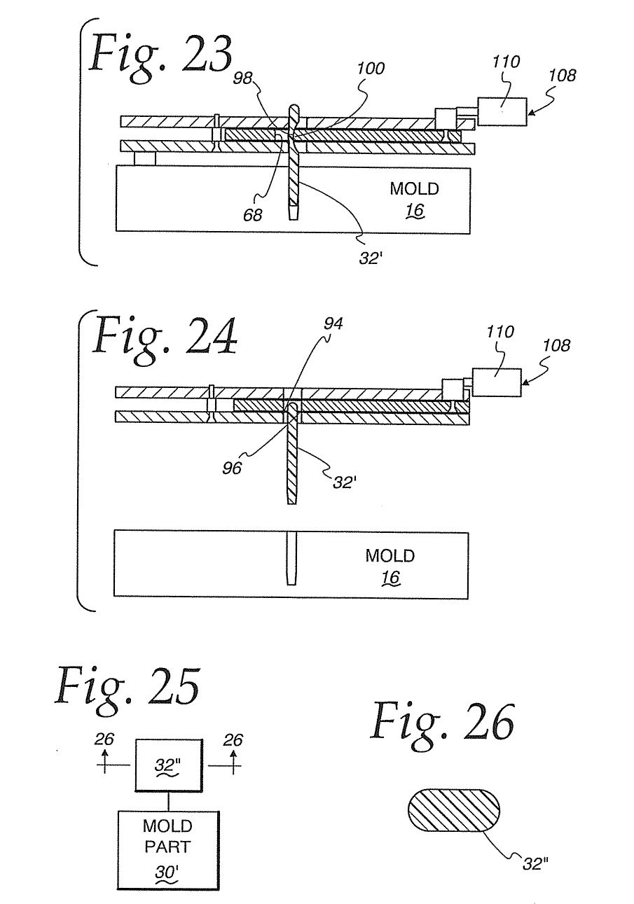

With the apparatus 52 in the gripping state of FIG. 22, the plate assembly 54 can be raised, whereby the scrap 28′ is separated from the mold part 26. Once this occurs, as shown in FIG. 8, with partial separation also shown in FIG. 23, the apparatus 52 can be placed back into the starting state through movement of the middle plate 60, as shown in FIG. 24, whereupon the projections 32′ will be released from the plate assembly 54, as shown also in FIG. 9.

In this embodiment, the apparatus 52 is supported on the frame 42 through a mounting base 102. The mounting base 102 supports a cylinder 104 with an extensible rod 106 that connects to the plate assembly 54. Retraction of the rod 106 places the plate assembly 54 in the retracted/inactive position shown in FIG. 6. The rod 106 can be extended to place the plate assembly 54 in the extended/operative position of FIG. 7.

The apparatus 52 is changed between its starting and gripping states by operating a grip actuating assembly 108. The grip actuating assembly 108 includes at least one, and in this case two, cylinders 110, of like construction, and each including an extendable rod 112 with a T-shaped bracket 114 driven in a line indicated by the double-headed arrow 116 in FIG. 19.

Each cylinder 110 is fixed to an upwardly facing surface 118 of the top plate 56. Each of the brackets 114 has a stem 120 that extends through a guide slot 122 on the upper plate 56 and is fixed to the middle plate 60 through fasteners 124. The fasteners 124 may be threaded fasteners that are tightened into threaded bores 126 on the middle plate 60. The cross bar 128 of the “T” is guided along the upwardly facing surface 118 on the upper plate 56 as the rod 112 is extended and retracted. By extending and retracting the rod 112, the middle plate 60 is translated relative to the top and bottom plates 56, 58 to allow the apparatus 52 to change between the starting and gripping states, shown respectively in FIGS. 20 and 22. Each guide slot 122 has a length L2 that is adequate to permit the necessary range of movement of the bracket 114 to allow both states for the apparatus 52 to be realized. The length L2 may be selected so that the slot ends consistently block the bracket 114, and thus the middle plate, movement to optimally set the starting and gripping states for the apparatus 52.

With the mold 16 initially positioned as in FIG. 4, the material from the supply 12 can be injected into the cavities 24. In the event the material is rubber, the material can be vulcanized. Thereafter, the mold assembly, made up of the mold parts, 26, 40, is moved to the staging position in FIG. 5 with the plate assembly 54 in the retracted/inactive position of FIG. 6. The rod 106 on the cylinder 104 is extended with the apparatus 52 in the starting state so that the projections 32′ on the scrap 28′ can be advanced through the registered plate openings 64, 66, 68.

With the plate assembly 54 in the extended/operative position of FIG. 7, the grip actuating assembly 108 can be operated to change the apparatus 52 from the starting state into the gripping state of FIG. 22, whereafter the plate assembly 54 can be elevated to the position shown in FIG. 8, whereupon the grip actuating assembly 108 can be operated to change the apparatus 52 from the gripping state back into the starting state, which allows the scrap 28′ to be released, as shown in FIG. 9.

Supplemental gripping of the scrap 28′ can be afforded by configuring the mold part 30′ to cause additional projections 32″, as shown in FIGS. 25 and 26, to be formed to nominally match with registrable openings 64′, 66′, 68′, on the plates 56, 58, 60, successively. The projections 32″ may be provided in the array shown or in any other pattern and in any number that is deemed appropriate based upon the tenacity with which the scrap may adhere to a particular mold part. The twelve openings 64′, 66′, 68′ in each plate represent but one exemplary form.

As noted above, the particular projection shape is not critical to the present invention. Further matching of the plate opening shape is not a requirement. It is important only that the plates be capable of cooperating to grip the particular projection with enough strength that the scrap will move with the particular plate assembly and separate from the mold.

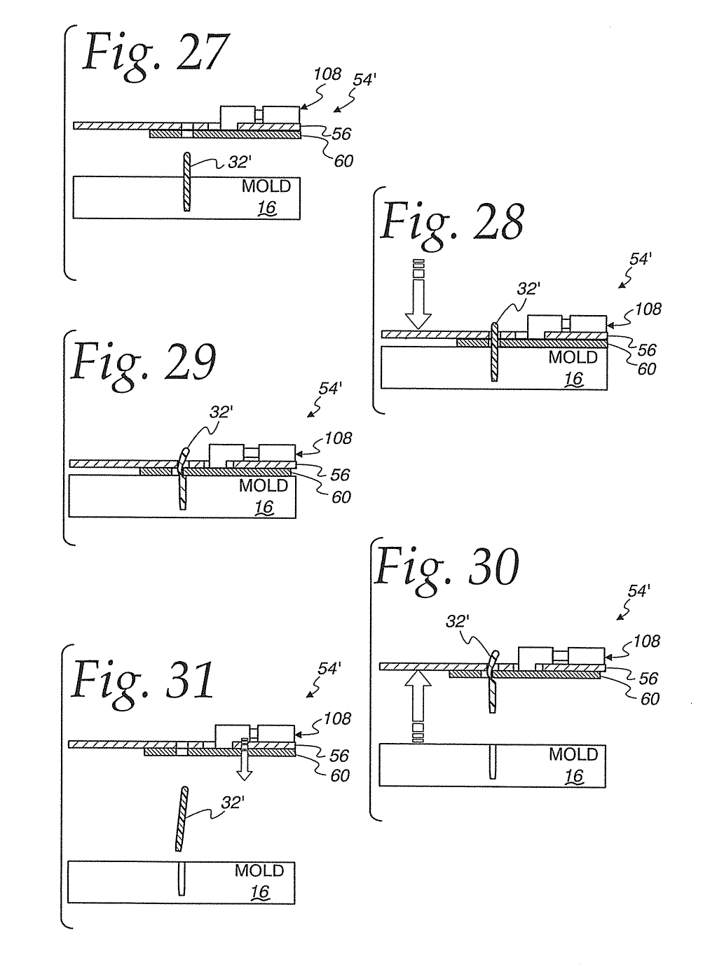

While the use of three plates 56, 58, 60 is preferred, this number is not required. The three plate arrangement provides good overall structural integrity and affords consistent and reliable operation. However, a modified form of plate assembly, as shown at 54′ in FIGS. 27-31, utilizes only the top plate 56 and middle plate 60 to produce the gripping action on the projections 32′. The two plate arrangement for the plate assembly 54′ allows the use of the same grip actuating assembly 108. The plates 56, 60 on the plate assembly 54′ cooperate with each other and the scrap 28′ on the mold 16 in the same manner that the plates 56, 60 and scrap 28 cooperate on the plate assembly 54. The sequence of drawings in FIGS. 26-30 corresponds successively with FIGS. 20-24, as hereinabove described.

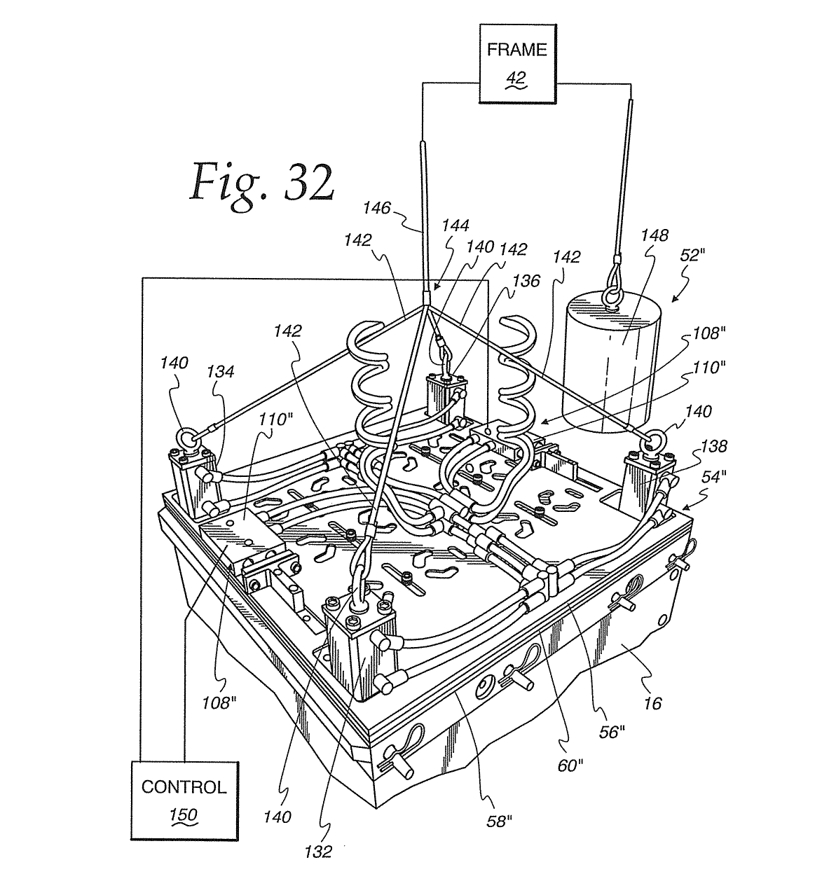

In FIGS. 32-36, a further modified form of apparatus is shown at 52″. The apparatus 52″ has a plate assembly 54″ that cooperates with a mold 16 in substantially the same manner that the plate assemblies 54, 54′ cooperate with the mold 16. The apparatus 52″ is at least partially manually operable. Rather than utilizing a cylinder, such as the cylinder at 104 used to raise and lower the plate assembly 54, the plate assembly 54″ is controlled through manual manipulation by an operator.

The plate assembly 54″ incorporates four corner posts 132, 134, 136, 138, each with an eye bolt 140. Separate cable lengths 142 extend from the eye bolts 140 angularly upwardly to a common juncture at 144. A single cable 146 extends therefrom to a counterweight 148. The cable 146 alone, or as part of another cable component or components, interacts with the frame 42 so that the weight of the counterweight 148 tensions the cable 146 to produce an upward force that effectively reduces the weight of the plate assembly 54″. By lowering the counterweight 148, the plate assembly 54″ is moved upwardly a corresponding distance. The weight of the counterweight 148 may be selected so that there is either full balancing or a slightly lesser force produced by the counterweight 148 on the cable 146.

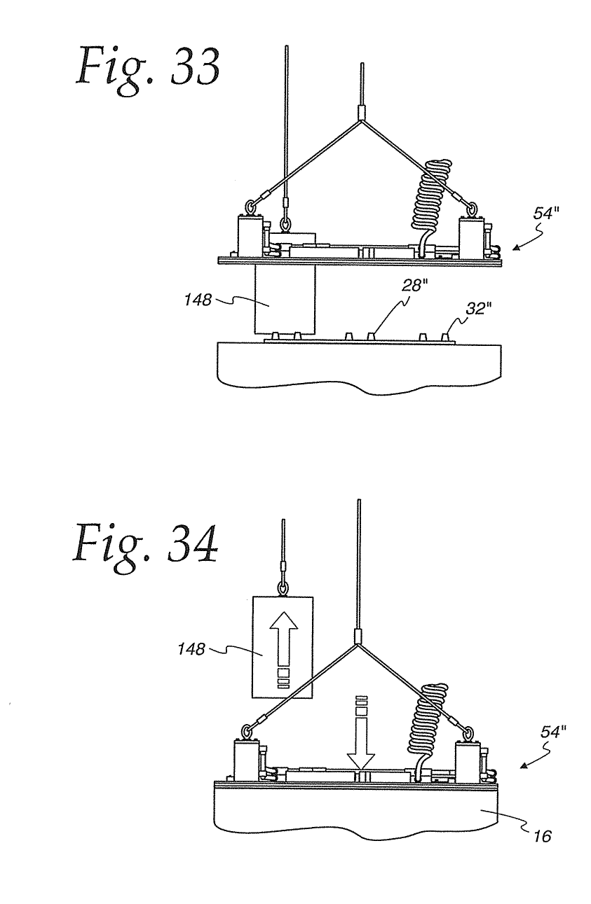

In operation, the plate assembly 54″ can be balanced in the FIG. 33 position. By exerting a downward force upon the plate assembly 54″, the counterweight 148 elevates. The operator can change the orientation and height of the counterbalanced plate assembly 54″ to allow potentially one-handed operation thereof. By aligning and lowering the plate assembly 54″ to the FIG. 34 position, the scrap 28″ can be engaged by directing projections 32″ thereon into plate openings (not shown).

Relative plate movement may be effected by a two component grip actuating assembly 108″, including spaced cylinders 110″ that operate in the same manner as the cylinders 110. Operation of the grip actuating assembly 108″ may be effected through a suitable control 150 that is on the frame 42 or one of the mold 16 or plate assembly 54″.

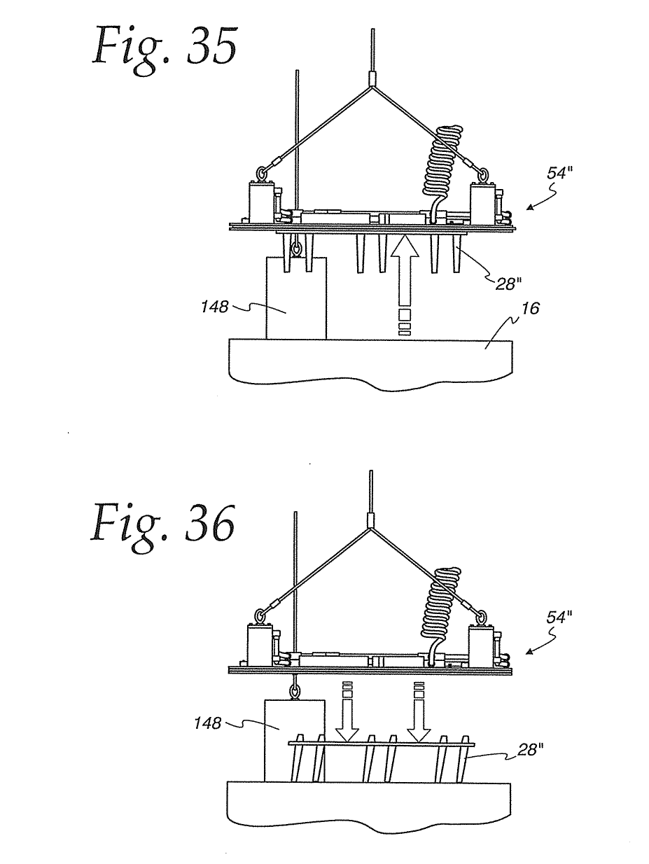

With the grip actuating assembly 108″ operated to place the apparatus 52″ in the gripping state, the plate assembly 54″ may be lifted manually, as indicated in FIG. 35, to draw the scrap 28″ away from the mold 16.

By then changing the apparatus 52″ from the gripping state back into the starting state, the scrap 28″ can be released from the plate assembly 54″, as shown in FIG. 36.

Details of the top and middle plates 56″, 60″, making up the plate assembly 54″, are not given herein since the construction of the plates 56″, 60″ is not critical to this design and may be either the same as, or different than, what has been described for the corresponding plates in the other embodiments hereinabove.

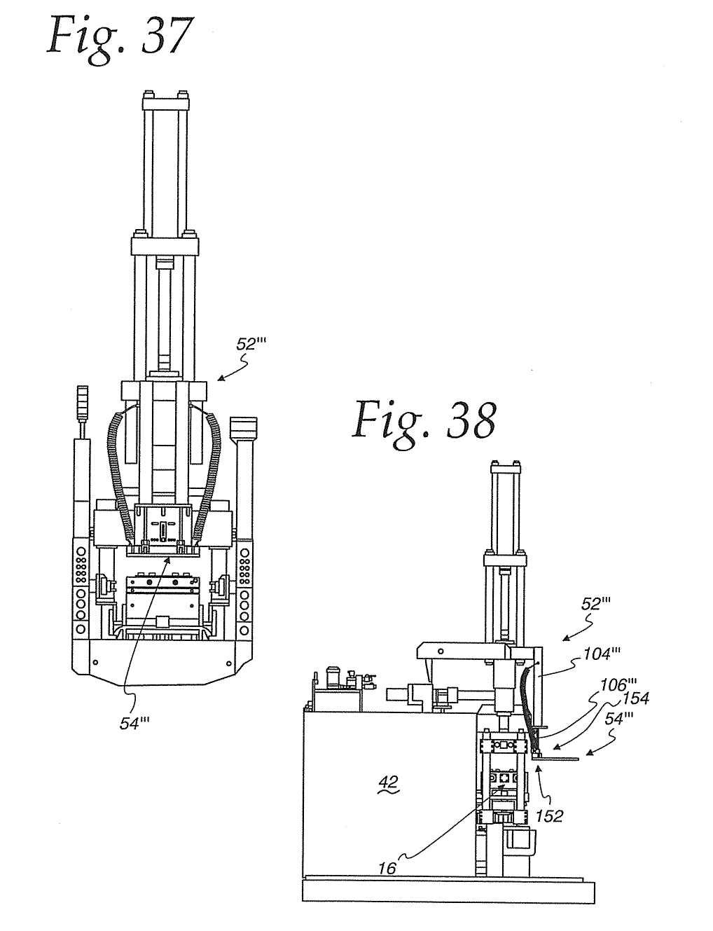

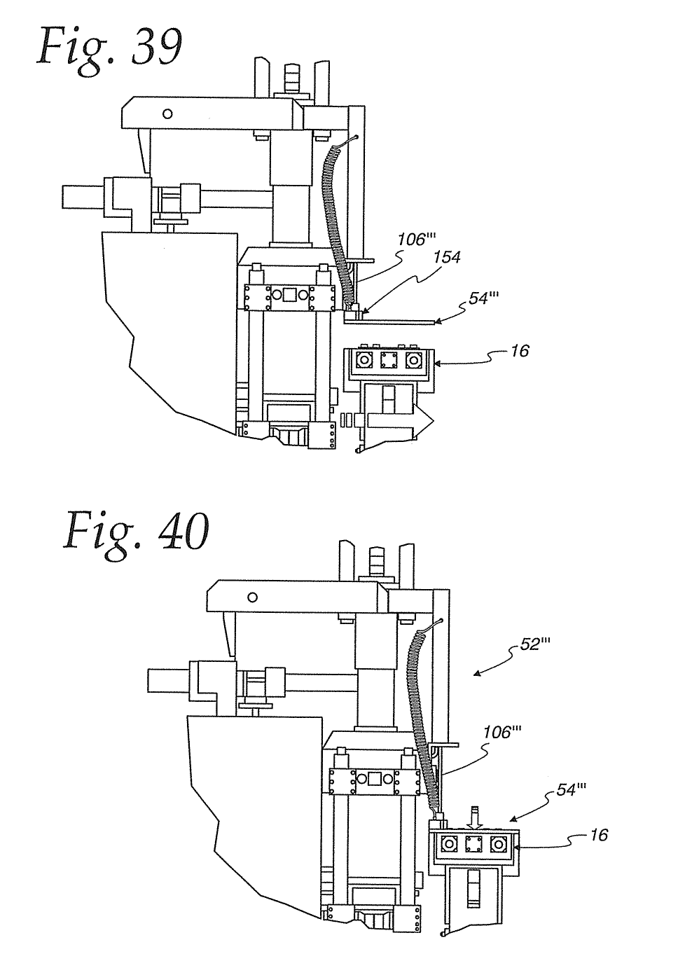

In FIGS. 37-42, a further modified form of apparatus is shown at 52″ with a plate assembly 54″ that is raised and lowered relative to the frame 42 through a cylinder 104′ with an extendable rod 106″.

Whereas the corresponding rod 106 in the earlier described embodiment has an end connected centrally of the plate assembly 54, the rod 106′ is connected to the plate assembly 54′ at an edge 152.

The primary difference between this embodiment and that shown in FIGS. 6-9 is that the rod 106″ is connected to the plate assembly 54″ through a mechanism at 154 that allows the plate assembly 54m to pivot relative to the rod 106″ about a horizontal axis 156. The plate assembly 54′ is moved through the cylinder 104″, and the plate assembly 54″ interacts with the scrap 28″, in the same manner as the corresponding components move and interact in the embodiment in FIGS. 6-9.

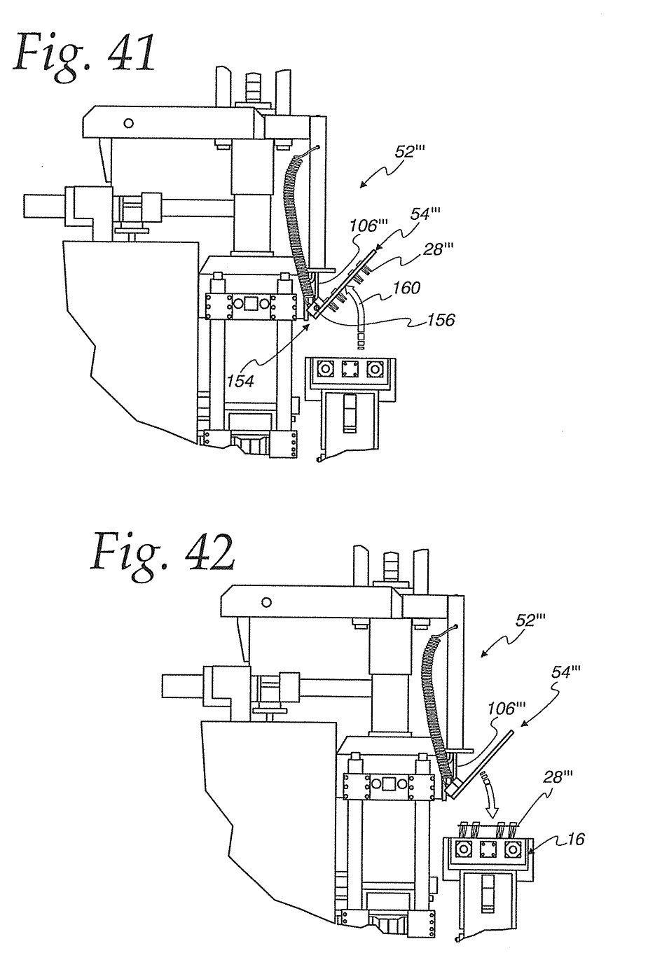

However, the hinge feature allows the gripped scrap 28″ to be released and removed with the plate assembly 54″ at a lower height. For example, as seen in FIG. 41, by pivoting in the plate assembly 54″ in the direction of the arrow 160, the scrap 28″ is readily accessible and can be separated from the plate assembly 54″, without any interference from the mold 16, and released as shown in FIG. 42.

The foregoing disclosure of specific embodiments is intended to be illustrative of the broad concepts comprehended by the invention.

1. An apparatus for separating mold scrap from a mold, the apparatus comprising:
a first plate having a first engaging edge;
a second plate having a second engaging edge,
one of the first and second plates overlying the other of the first and second plates; and
a grip actuating assembly for moving at least one of the first and second plates relative to the other of the first and second plates in a first path to change the apparatus between: a) starting state wherein a projecting piece of mold scrap can be directed to between the first and second engaging edges; and b) a gripping state wherein a projecting piece of mold scrap between the first and second edges with the apparatus in the starting state is gripped by the first and second engaging edges,
whereupon the first and second plates can be repositioned in a second path to separate the gripped projecting piece of mold scrap from an associated mold upon which the projecting piece of mold scrap is formed.

2. The apparatus for separating mold scrap according to claim 1 wherein the first path is substantially straight.

3. The apparatus for separating mold scrap according to claim 1 wherein the first plate has a first flat surface and the second plate has a second flat surface, the first and second flat surfaces respectively residing in substantially parallel first and second planes and facing each other, the first path substantially parallel to the first and second planes.

4. The apparatus for separating mold scrap according to claim 3 wherein the apparatus further comprises a third plate having a third engaging edge and the second plate resides between the first and third plates, with the apparatus in the starting state a projecting piece of mold scrap can be directed between the second and third edges and by changing the apparatus from the starting state into the gripping state a projecting piece of mold scrap between the second and third edges with the apparatus in the starting state is gripped by the second and third engaging edges, whereupon the first, second and third plates can be relatively repositioned to separate the piece of mold scrap gripped between the first and second engaging edges and second and third engaging edges from an associated mold upon which the projecting piece of mold scrap is formed.

5. The apparatus for separating mold scrap according to claim 4 wherein the second plate has another flat surface that is substantially parallel with and faces oppositely to the second surface, the third plate has a third flat surface, the third flat surface and another flat surface respectively residing in substantially parallel third and another flat planes and facing each other.

6. The apparatus for separating mold scrap according to claim 5 wherein the third plate is movable with the first and second plates in the second path to separate the gripped projecting piece of mold scrap from a mold and the second path is substantially orthogonal to the first path.

7. The apparatus for separating mold scrap according to claim 1 further comprising a support for the first and second plates.

8. The apparatus for separating mold scrap according to claim 7 further comprising a drive assembly for selectively moving the first and second plates in opposite directions in the second path.

9. The apparatus for separating mold scrap according to claim 1 further comprising: a) a support for the first and second plates, the first and second plates movable through the support vertically in the second path; and b) a counterbalance assembly, the counterbalance assembly cooperating with the first and second plates to counterbalance a weight of the first and second plates to thereby facilitate raising of the first and second plates.

10. The apparatus for separating mold scrap according to claim 1 wherein there is at least one other engaging edge on each of the first and second plates that cooperate with each other and a projecting piece of mold scrap in the same way the first and second engaging edges cooperate with each other and a projecting piece of mold scrap.

11. The apparatus for separating mold scrap according to claim 4 wherein there is at least one other engaging edge on each of the first, second, and third plates that cooperate with each other and a projecting piece of mold scrap in the same way the first, second, and third engaging edges cooperate with each other and a projecting piece of mold scrap.

12. The apparatus for separating mold scrap according to claim 1 in combination with a mold assembly with mold scrap including the projecting piece of mold scrap thereon and the projecting piece of mold scrap has a projecting length and the projecting piece of mold scrap has a substantially circular peripheral shape in cross-section taken transversely to the projecting length.

13. The apparatus for separating mold scrap according to claim 12 wherein the first and second engaging edges each is substantially U-shaped, with the “U” shape of each of the first and second edges opening towards each other.

14. The apparatus for separating mold scrap according to claim 13 wherein the mold assembly has openings in which the mold scrap resides.

15. A method of using the apparatus as set forth in claim 10, the method comprising the steps of:
providing a mold assembly;
directing mold material into the mold assembly to produce at least one part and mold scrap including at least first and second projecting pieces of mold scrap that project in parallel lines;
placing the apparatus in the starting state,
with the apparatus in the starting state moving the first and second plates in a first direction in the second path to thereby direct the first projecting piece of mold scrap between the first and second edges and the second and third edges and the second projecting piece of mold scrap between the one other of the engaging edges on the first and second plates and second and third plates;
changing the apparatus from the starting state into the gripping state so that: a) the first projecting piece of mold scrap between the first and second engaging edges and second and third engaging edges is gripped by the first and second engaging edges and second and third engaging edges; and b) the second projecting piece of mold scrap between the one other of the engaging edges on the first, second and third plates is gripped by the one other of the engaging edges on the first and second plates and second and third plates; and
with the apparatus in the gripping state moving the first and second plates oppositely to the first direction in the second path relative to the mold assembly to thereby separate at least a part of the mold scrap from the mold assembly.

16. The method of using the apparatus according to claim 15 wherein the method is performed with the apparatus on a base upon which the mold assembly is provided and using a drive assembly, wherein the steps of moving the first and second plates in the first direction and oppositely to the first direction in the second path comprises moving the first and second plates by operating the drive assembly.

17. The method of using the apparatus according to claim 15 wherein the method is performed with the apparatus on a base upon which the mold assembly is provided, wherein the step of moving the first and second plates in the first direction and oppositely to the first direction in the second path comprises manually engaging and moving the first and second plates relative to the mold assembly.

18. The method of using the apparatus according to claim 15 further comprising the step of changing the apparatus from the gripping state back into the starting state after the at least part of the mold scrap is separated from the mold assembly to thereby allow release of the at least part of the mold scrap from the apparatus.

19. The method of using the apparatus according to claim 17 further comprising the step of counterbalancing a weight of the first and second plates to facilitate manual movement of the first and second plates.

20. The method of using the apparatus according to claim 15 wherein the step of directing mold material into the mold assembly comprises injecting the mold material into the mold assembly.
